(19) United States
(12) Patent Application Publication
(10) Pub. No.: US 2016/0155093 A1
(43) Pub. Date: Jun. 2, 2016

(54) IMAGE-FORMING-APPARATUS CONTROL SYSTEM, CONTROL METHOD, AND COMPUTER PROGRAM PRODUCT

(71) Applicants: Yuto SHIBATA, Kanagawa (JP); Daisuke OKADA, Saitama (JP); Chan GU, Tokyo (JP); Keisuke NAKAZAWA, Kanagawa (JP); Hiroya URUTA, Tokyo (JP); Akiko KITAYAMA, Kanagawa (JP); Yuka SAITO, Tokyo (JP)

(72) Inventors: Yuto SHIBATA, Kanagawa (JP); Daisuke OKADA, Saitama (JP); Chan GU, Tokyo (JP); Keisuke NAKAZAWA, Kanagawa (JP); Hiroya URUTA, Tokyo (JP); Akiko KITAYAMA, Kanagawa (JP); Yuka SAITO, Tokyo (JP)

(73) Assignee: Ricoh Company, Limited, Tokyo (JP)

(21) Appl. No.: 14/955,884

(22) Filed: Dec. 1, 2015

(30) Foreign Application Priority Data
Dec. 2, 2014 (JP) 2014-244475

(51) Int. Cl. G06Q 10/10; G06F 21/62; G06Q 40/00

(52) U.S. Cl. CPC G06Q 10/1091; G06Q 40/125; G06F 21/6218

(57) ABSTRACT

A main body of the image forming apparatus includes a first user-information storage unit configured to store user information. An information processing terminal includes: a data processing unit configured to acquire attendance information; a user-information processing unit configured to acquire, from the main body of the image forming apparatus, user information of a user who has clocked in determined based on the attendance information and acquire user information read in by the reader from the user-information recording medium for user authentication; and, a second user-information storage unit configured to store the user information of the user who has clocked in. The user-information processing unit being configured to perform user authentication by using the user information stored by the second user-information storage unit and the user information read in by the reader from the user-information recording medium for user authentication.

### CROSS-REFERENCE TO RELATED APPLICATIONS

The present application claims priority to and incorporates by reference the entire contents of Japanese Patent Application No. 2014-244475 filed in Japan on Dec. 2, 2014.

### BACKGROUND OF THE INVENTION

1. Field of the Invention

The present invention relates generally to an image-forming-apparatus control system, a control method, and a computer program product.

2. Description of the Related Art

In recent years, using an image forming apparatus such as a multifunction peripheral in an office in user authentication through an ID (identification) card (e.g., IC (integrated circuit) card) is becoming increasingly common. However, it is often the case that an image forming apparatus that is not in use is put in an energy saving mode for the sake of power saving, and time taken to exit from the energy saving mode impairs user's convenience in user authentication using an ID card. Put another way, time taken to exit from the energy saving mode is an important factor for user's convenience in user authentication using an ID card.

There is a need to reduce waiting time in user authentication in an image forming apparatus in which the user authentication is performed by using a user-information recording medium such as an ID card in an operating unit that accepts user's operation.

### SUMMARY OF THE INVENTION

It is an object of the present invention to at least partially solve the problems in the conventional technology.

An image-forming-apparatus control system includes: a main body; and an information processing terminal used as an operating unit of the image forming apparatus, controlled independently of the main body of the image forming apparatus and including a reader configured to read in user information from a user-information recording medium. The main body of the image forming apparatus includes a first user-information storage unit configured to store user information. The information processing terminal includes: a data processing unit configured to acquire attendance information; a user-information processing unit configured to acquire, from the main body of the image forming apparatus, user information of a user who has clocked in determined based on the attendance information and acquire user information read in by the reader from the user-information recording medium for user authentication; and a second user-information storage unit configured to store the user information of the user who has clocked in, acquired from the main body of the image forming apparatus. The user-information processing unit being configured to perform user authentication by using the user information stored by the second user-information storage unit and the user information read in by the reader from the user-information recording medium for user authentication.

A control method is for an image-forming-apparatus control system for an image forming apparatus including a main body and an information processing terminal used as an operating unit of the image forming apparatus, controlled independently of the main body of the image forming apparatus and including a reader for reading in user information from a user-information recording medium. The control method includes: in the main body of the image forming apparatus, storing, by a first user-information storage unit, user information; in the information processing unit, acquiring, by a data processing unit, attendance information; acquiring, by a user-information processing unit, user information of a user who has clocked in determined based on the attendance information from the main body of the image forming apparatus; storing, by a second user-information storage unit, the user information of the user who has clocked in, acquired from the main body of the image forming apparatus; acquiring, by the user-information processing unit, user information read in by the reader from the user-information recording medium for user authentication; and performing, by the user-information processing unit, user authentication by using the user information stored by the second user-information storage unit and the user information read in by the reader from the user-information recording medium for user authentication.

A computer program product includes a non-transitory computer-readable medium containing an information processing program for an image-forming-apparatus control system for an image forming apparatus including a main body storing therein user information, and an information processing terminal used as an operating unit of the image forming apparatus, controlled independently of the main body of the image forming apparatus and including a reader for reading in user information from a user-information recording medium. The program causes a computer of the image-forming-apparatus control system to perform: acquiring attendance information; acquiring, from the main body of the image forming apparatus, user information of a user who has clocked in determined based on the attendance information; storing the user information of the user who has clocked in acquired from the main body of the image forming apparatus; acquiring user information read in by the reader from the user-information recording medium for user authentication; and performing user authentication by using the user information stored at the storing and the user information read in by the reader from the user-information recording medium for user authentication.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic hardware structure of an image forming apparatus according to a first embodiment;

FIG. 2 is a diagram illustrating software architecture of the image forming apparatus according to the first embodiment;

FIG. 3A is a diagram illustrating an example of user information;

FIG. 3B is a diagram illustrating an example of attendance information;

FIG. 4 is an explanatory diagram illustrating an overview of operations for user authentication performed by an operating unit alone;

FIG. 5 is a diagram illustrating an example of entry of attendance information in attendance information management using the image forming apparatus;

FIG. 6A is a diagram illustrating a flow of operations (of the operating unit) related to acquisition of user information in response to entry of attendance information in the image forming apparatus according to the first embodiment;

FIG. 6B is a diagram illustrating a flow of operations (of a controller) related to acquisition of the user information in response to entry of the attendance information in the image forming apparatus according to the first embodiment;

FIG. 7A is a diagram illustrating a flow of operations (of the operating unit) for user authentication using stored user information and an ID card in the image forming apparatus according to the first embodiment;

FIG. 7B is a diagram illustrating a flow of operations (of the controller) for user authentication by using the stored user information and the ID card in the image forming apparatus according to the first embodiment;

FIG. 8 is a diagram illustrating software architecture of the image forming apparatus according to a second embodiment;

FIG. 9A is a diagram illustrating a flow of operations (of the operating unit) to be performed when attendance information is entered in the image forming apparatus according to the second embodiment;

FIG. 9B is a diagram illustrating a flow of operations (of the operating unit) at switching to an energy saving mode in the image forming apparatus according to the second embodiment;

FIG. 9C is a diagram illustrating a flow of operations (of the controller) at switching to the energy saving mode in the image forming apparatus according to the second embodiment;

FIG. 10 is a diagram illustrating software architecture of the image forming apparatus according to a third embodiment;

FIG. 11A is a diagram illustrating a flow of operations (of the operating unit) related to acquisition of user information in the image forming apparatus according to the third embodiment;

FIG. 11B is a diagram illustrating a flow of operations (of the controller) related to acquisition of the user information in the image forming apparatus according to the third embodiment;

FIG. 12 is a diagram illustrating software architecture of the image forming apparatus according to a fourth embodiment;

FIG. 13A is a diagram illustrating a flow of operations (of the operating unit) related to acquisition of user information in the image forming apparatus according to the forth embodiment; and

FIG. 13B is a diagram illustrating a flow of operations (of an external server and the controller) related to acquisition of the user information in the image forming apparatus according to the forth embodiment.

### DETAILED DESCRIPTION OF THE PREFERRED EMBODIMENTS

Exemplary embodiments of the present invention are described in detail below with reference to the accompanying drawings.

In the present specification, the term “user information” refers to user information, such as an employee number and/or an ID card number, necessary for authentication. The term “attendance information” refers to per-user information as to “whether the user is present or absent” or “what time the user has clocked in and what time the user has clocked out” in a certain day.

### First Embodiment

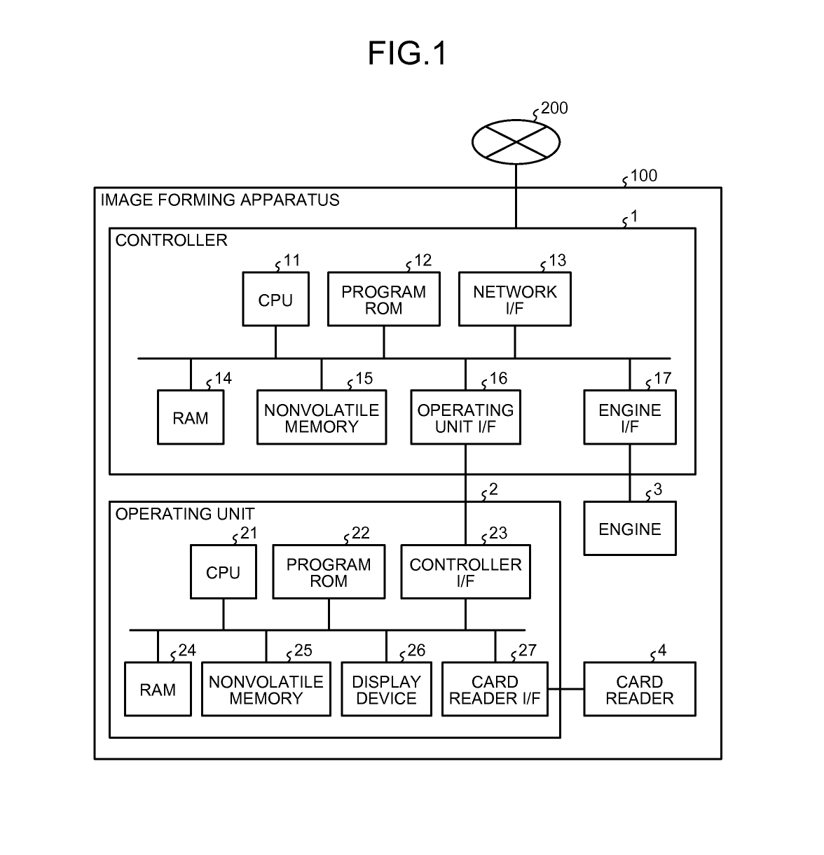

FIG. 1 is a diagram illustrating a schematic hardware structure of an image forming apparatus according to a first embodiment.

An image forming apparatus 100 includes a controller 1, an operating unit 2, an engine 3, and a card reader 4. The operating unit 2 is controlled independently of the controller 1. The operating unit 2 may be configured as an information processing terminal removably attachable to or independent of a main body of the image forming apparatus 100. The term “main body of the image forming apparatus” is used to differentiate the operating unit 2 (the information processing terminal) controlled independently of the controller 1 from the “main body of the image forming apparatus” controlled by the controller 1 even when the operating unit 2 is in one piece with the main body of the image forming apparatus 100.

The controller 1, which serves as a main control unit of the image forming apparatus 100, performs status management and job control of the image forming apparatus 100. The controller 1 includes the following elements.

A CPU 11 is a central processing unit included in the controller 1. The CPU 11 performs various types of computations, and controls the engine 3 and the elements included in the controller 1 in accordance with control program instructions (hereinafter, “control programs”) for the controller 1.

A program ROM 12 stores therein the control programs, which are to be executed by the CPU 11, related to general power supply management (including control for switching to an energy saving mode and exiting from the energy saving mode), the job control, user authentication, and the like.

A network I/F 13 is an interface for carrying out communication with an external network 200.

A RAM 14 is a main memory of the CPU 11. The control programs stored in the program ROM 12 are loaded into the RAM 14 at startup. The RAM 14 is used also as a work memory, into which a print image and the like are to be loaded.

A nonvolatile memory 15 stores therein accumulated document data, data necessary for loading an image, user information for use in user authentication, which will be described later, attendance information, and the like.

An operating unit I/F 16 is an interface for carrying out communication with the operating unit 2.

An engine I/F 17 is an interface for carrying out communication with the engine 3.

The operating unit 2 is described below. The operating unit 2 is a device (information processing terminal) including a CPU and a storage area, which are independent of the controller 1, and performs control related to screen display of the operating unit 2 and control for accepting user's input operation performed on the operating unit 2. The operating unit 2 includes the following elements.

A CPU 21 is a central processing unit included in the operating unit 2. The CPU 21 controls the screen display, accepts user's input operation, acquires user information, which will be described later, and performs an authentication process and the like in accordance with control programs for the operating unit 2.

A program ROM 22 stores therein the control programs to be executed by the CPU 21.

A controller I/F 23 is an interface for carrying out communication with the controller 1.

A RAM 24 is a main memory of the CPU 21. The control programs stored in the program ROM 22 are to be loaded into the RAM 24. The RAM 24 is used also as a work memory for the authentication process and the like.

A nonvolatile memory 25 stores therein initial values for startup and data of items that can be set. In the first embodiment, the nonvolatile memory 25 also stores therein attendance information and user information acquired by the operating unit 2 from the controller 1.

A display device 26 includes a liquid crystal panel for display and a touch panel for input operations by a user.

A card reader I/F 27 is an interface for carrying out communication with the card reader 4.

The engine 3 and the card reader 4 are described below. The engine 3 is a device for forming an image of a print image generated by the controller 1 on printing paper. The card reader 4 is a device for reading in user information or the like recorded in an ID card serving as a user-information recording medium from the ID card. The ID card may be an IC card or a magnetic card. User information of one of users is recorded in the ID card.

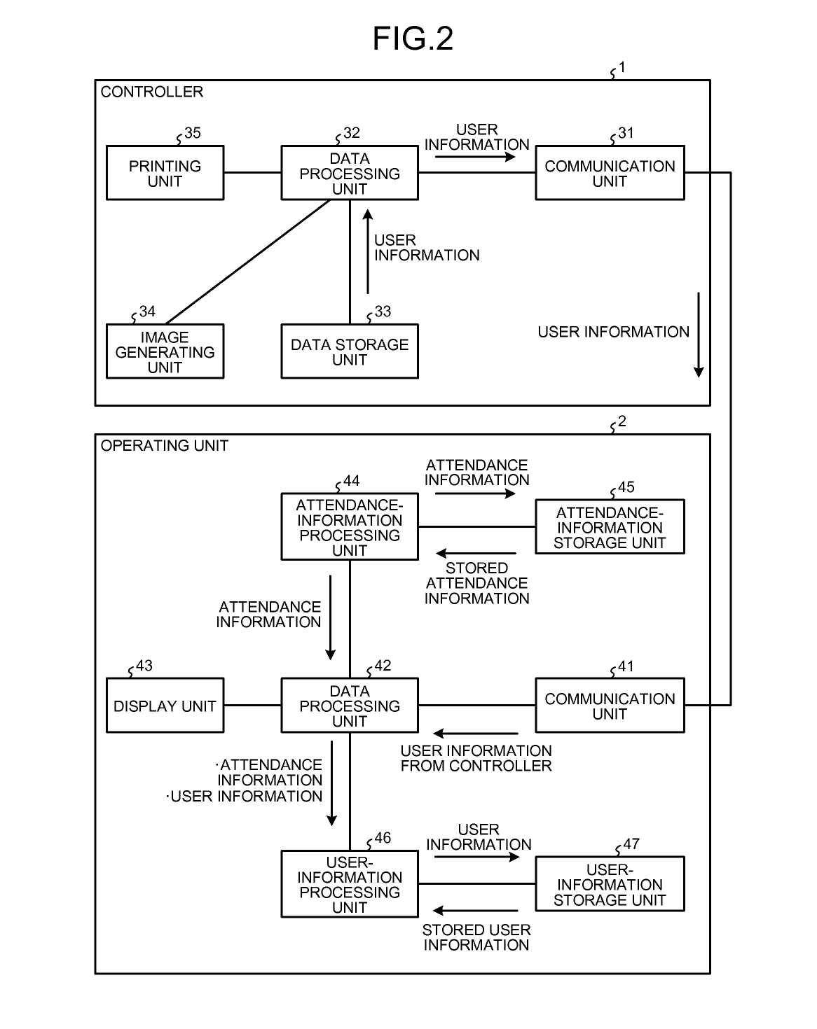

Software architecture of the controller 1 and the operating unit 2 serving as a control system of the image forming apparatus 100 according to the first embodiment is described below with reference to FIG. 2.

The software architecture of the controller 1 includes a communication unit 31, a data processing unit 32, a data storage unit 33, an image generating unit 34, and a printing unit 35 as illustrated in FIG. 2.

The communication unit 31 controls data exchange to and from an external host (not shown) on the network 200 via the network I/F 13. In the first embodiment, the communication unit 31 also controls communication with the operating unit 2 via the operating unit I/F 16.

The data processing unit 32 controls operations of the entire controller 1 depending on usage status of the image forming apparatus 100.

The data storage unit 33 performs control for storing an accumulated job(s) and other data in the nonvolatile memory 15. The data storage unit 33 also manages, as a first user-information storage unit, user information of all users of the image forming apparatus 100.

The image generating unit 34 loads data of a print job and draws a print image on the RAM 14 serving as an image memory.

The printing unit 35 controls the engine 3 via the engine I/F 17, thereby causing the engine 3 to print the print image drawn on the image memory (the RAM 14) on printing paper.

The software architecture of the operating unit 2 is described below. The software architecture of the operating unit 2 includes a communication unit 41, a data processing unit 42, a display unit 43, an attendance-information processing unit 44, an attendance-information storage unit 45, a user-information processing unit 46, and a user-information storage unit 47.

The communication unit 41 controls data exchange to and from the controller 1 via the controller I/F 23.

The data processing unit 42 interprets user's operation entered from the display device 26 to control operations of the operating unit 2. Furthermore, the data processing unit 42 controls acquisition of user information stored in the controller 1 and acquisition of attendance information. In the first embodiment, as will be described in detail later, the data processing unit 42 is configured to acquire user information pieces determined to have high priority among user information pieces stored in the controller 1.

The display unit 43 performs display control of the display device 26. The display unit 43 also transfers information (e.g., input data and information about what operation is performed by a user) entered by a user by operating the touch panel of the display device 26 to the data processing unit 42.

The attendance-information processing unit 44 accepts attendance information entered by a user (which may be directly entered to the display device 26 or entered using an ID card to be read by the card reader 4), causes the attendance-information storage unit 45 to store the accepted attendance information, and manages the attendance information.

The attendance-information storage unit 45 stores therein per-user attendance information accepted by the attendance-information processing unit 44 in the nonvolatile memory 25.

The user-information processing unit 46 receives, from the data processing unit 42, the attendance information accepted by the attendance-information processing unit 44 and compares the attendance information against user information (hereinafter, sometimes referred to as “stored user information”) stored by the user-information storage unit 47 in the nonvolatile memory 25. If not-yet-stored user information is found, the user-information processing unit 46 acquires corresponding user information from the controller 1 via the data processing unit 42 and the communication unit 41, and causes the user-information storage unit 47 to store the user information.

The user-information storage unit 47 stores, as a second user-information storage unit, the user information acquired by the user-information processing unit 46 from the controller 1 in the nonvolatile memory 25.

The units described above as the software architecture are configured as modules and stored in the program ROMs (which are the program ROM 12 in the controller 1 and the program ROM 22 in the operating unit 2) as control programs. At startup, each of the CPUs (which are the CPU 11 in the controller 1 and the CPU 21 in the operating unit 2) loads corresponding control programs from a corresponding one of the program ROMs (which are the program ROM 12 in the controller 1 and the program ROM 22 in the operating unit 2) into a corresponding one of the main storage devices (which are the RAM 14 in the controller 1 and the RAM 24 in the operating unit 2), thereby generating the units on the main storage device for the CPU.

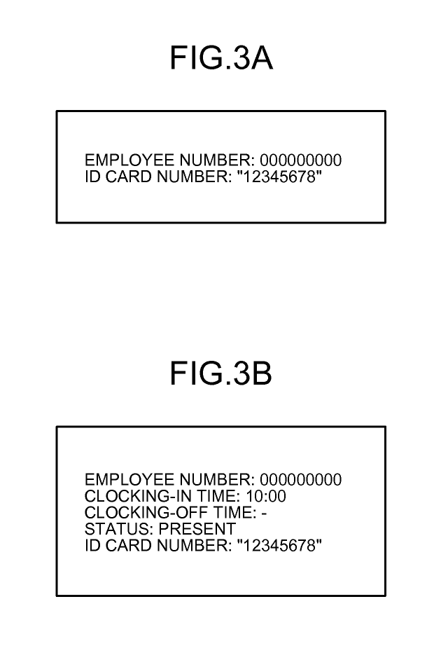

An example of user information and an example of attendance information are illustrated in FIG. 3A and FIG. 3B, respectively. The user information is information containing an employee number and an ID card number as illustrated in FIG. 3A. The attendance information is information containing an employee number, clocking-in time, clocking-off time, status (“present” or “not clocked in yet”), and an ID card number as illustrated in FIG. 3B. The user-information processing unit 46 can find not-yet-stored user information based on any one or both of the employee number and the ID card number, which are contained in each of the stored user information and the attendance information accepted by the attendance-information processing unit 44. Note that each of FIGS. 3A and 3B illustrates only an example, and user information is not limited to an employee number and an ID card number. Any information can be used as the user information so long as a user can be identified by the information. Attendant information is not limited to an employee number and an ID card number, and any information can be used as the attendant information so long as the information contains information, by which a user can be identified, in addition to information indicating an attendance status.

How, when the image forming apparatus 100 is in the energy saving mode, the image forming apparatus 100 operates to implement ID card authentication using the operating unit 2 alone without waiting for the controller 1 to exit from the energy saving mode is described below.

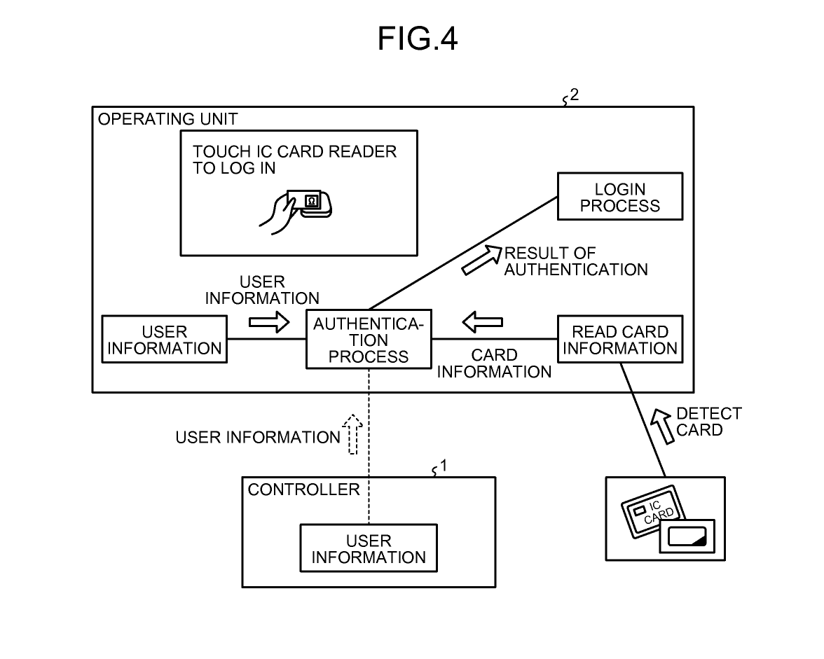

FIG. 4 is an explanatory diagram illustrating an overview of the operations for user authentication performed by the operating unit 2 alone.

When the image forming apparatus 100 is not in the energy saving mode and the controller 1 and the operating unit 2 are carrying out communication, the operating unit 2 acquires user information stored in the controller 1 and stores the user information.

However, when no external operation is performed on the image forming apparatus 100 for a certain period of time, the image forming apparatus 100 enters the energy saving mode. In the energy saving mode, connection (communication) between the controller 1 and the operating unit 2 is cut off.

If an ID card is brought close to the card reader 4 when the image forming apparatus 100 is in the energy saving mode, the card reader 4 detects the ID card and reads in card information. At this time, the operating unit 2 and the controller 1 start starting up.

The operating unit 2 receives the card information (which is user information in this example) read in by the card reader 4 from the ID card and performs user authentication (the authentication process) by checking the user information recorded in the ID card against user information stored in the operating unit 2. The operating unit 2 then performs a login process depending on a result of the authentication.

Through the operations described above, user authentication can be implemented using the operating unit 2 alone without waiting for the controller 1 to start up and reestablish connection with the operating unit 2.

Meanwhile, the nonvolatile memory 25 included in the operating unit 2 is generally smaller in capacity than that used in the controller 1. Accordingly, it is impractical to cause the whole user information stored in the controller 1 to be stored in the nonvolatile memory 25 included in the operating unit 2. It is also impractical to employ a large-capacity nonvolatile memory to store the whole user information stored in the controller 1 in the operating unit 2. For these reasons, user information of some users or, put another way, a predetermined number of pieces (e.g., 50 pieces or 100 pieces) of the user information is preferably stored in the operating unit 2.

However, if user information of arbitrary users among the user information stored in the controller 1 is stored in the operating unit 2, a situation that user information of a user to be authenticated is not stored in the operating unit 2 can occur. In such a situation, an authorized user is required to wait, before logging into the image forming apparatus 100, until communication is established between the operating unit 2 and the controller 1 and, additionally, until the operating unit 2 acquires user information of the user from the controller 1. Hence, a problem that user's waiting time can undesirably increase arises.

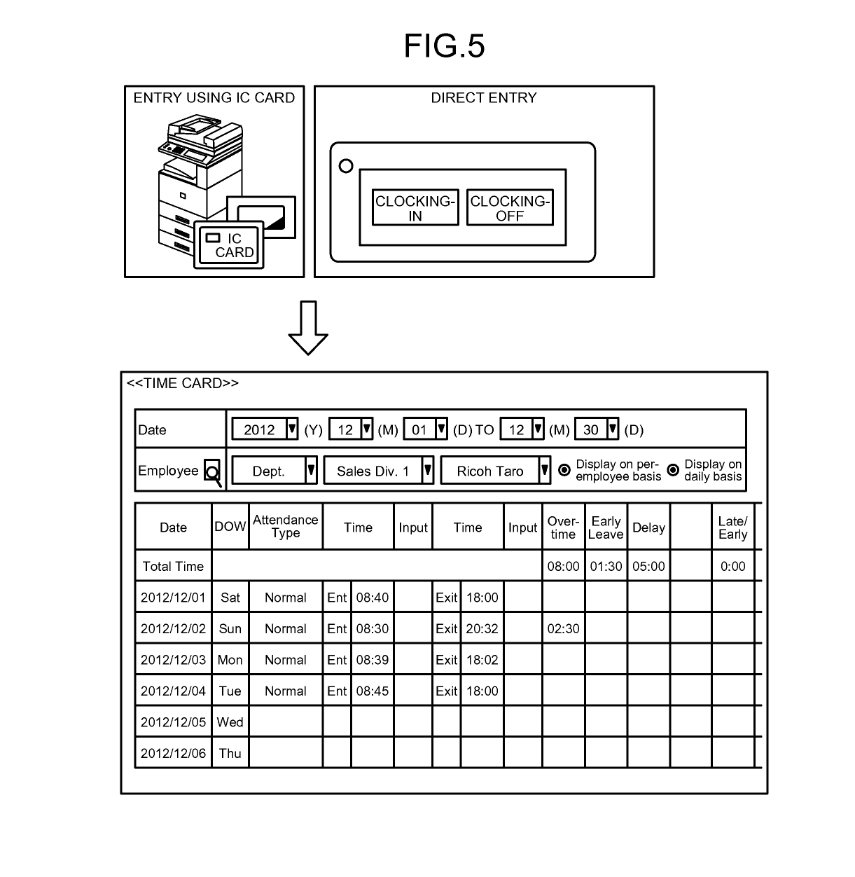

Therefore, in the first embodiment, the operating unit 2 acquires user information of users who are highly likely to use the image forming apparatus 100 with higher priority than the other users from the controller 1. As a result, accuracy of effective user information stored in the operating unit 2 increases and frequency that a user has long waiting time decreases. To implement this scheme, the first embodiment utilizes attendance information accumulated in the image forming apparatus 100. More specifically, accuracy of effective user information acquired by the operating unit 2 is increased by acquiring user information of users who are currently in the state of being present with high priory. As for the attendance information, a technology of managing an employee attendance status (time card) by bringing an IC card close to an image forming apparatus and associating the attendance information with attendance management software and/or salary calculation software is already known. The image forming apparatus 100 can utilize the attendance information by utilizing such a technology. The attendance information may be directly entered from the operating unit 2 of the image forming apparatus 100 (FIG. 5). Meanwhile, because entry of attendance information is merely entry of information, user authentication is not required.

As described above, in the first embodiment, attendance information stored in the image forming apparatus 100 is utilized to increase accuracy of effective user information stored in the operating unit 2. How the image forming apparatus 100 acquires user information and manages attendance information in response to entry of attendance information is described below.

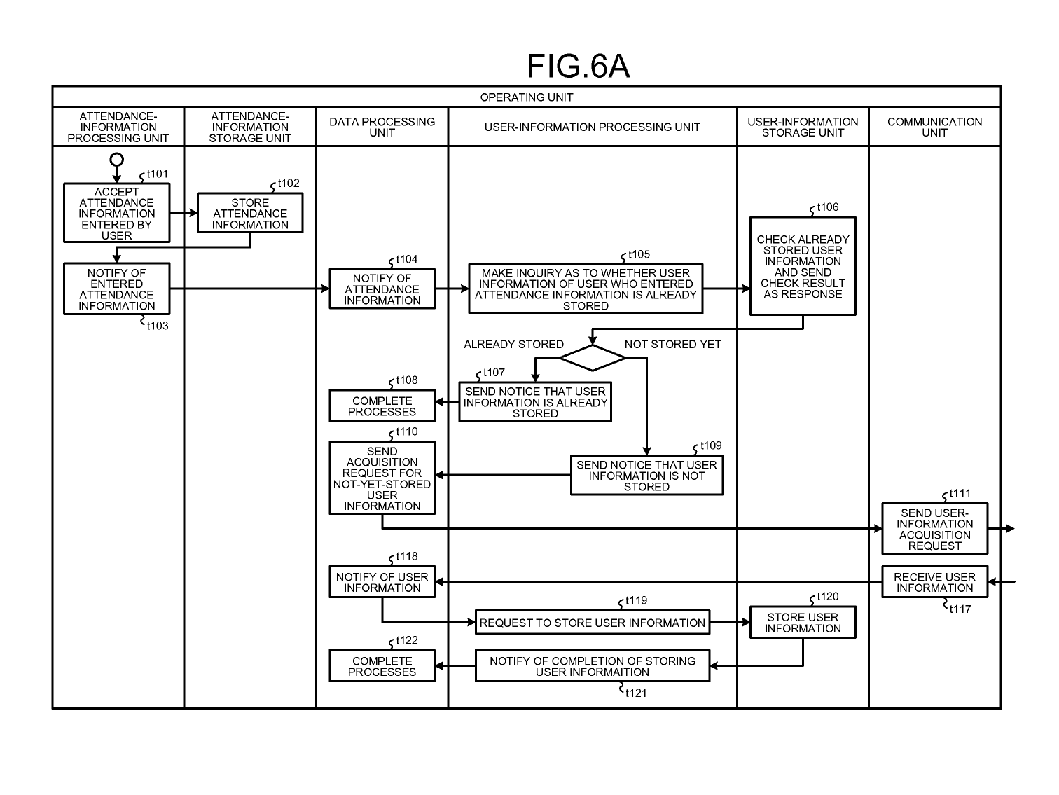

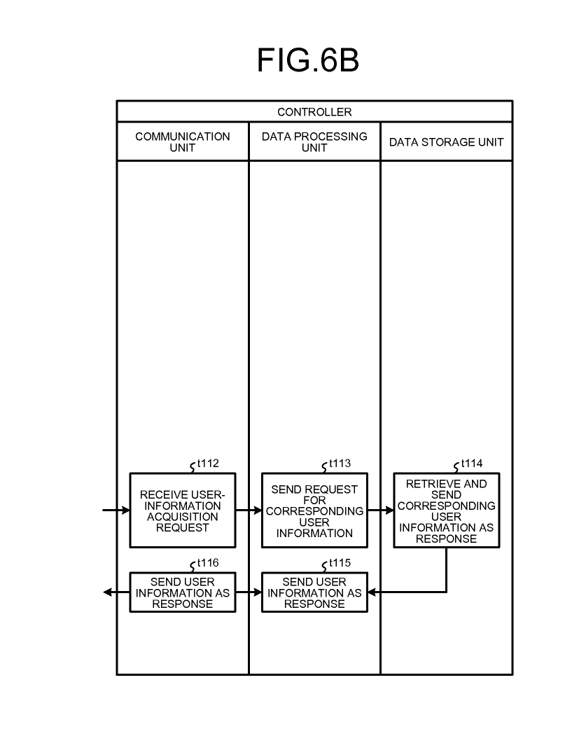

Operations related to acquisition of user information in response to entry of attendance information are described below with reference to FIGS. 6A and 6B. The arrows illustrated in FIGS. 6A and 6B and other drawings indicate flow (order) of processing.

When attendance information is entered by a user directly to the operating unit 2 or by using an ID card, the attendance-information processing unit 44 accepts the attendance information (t101). The attendance-information storage unit 45 stores the entered attendance information in the nonvolatile memory 25 of the operating unit 2 (t102). Furthermore, the attendance-information processing unit 44 notifies the data processing unit 42 of the entered attendance information (t103). The data processing unit 42 notifies a data-information processing unit of the attendance information (or user information contained in the attendance information) (t104).

The user-information processing unit 46 makes inquiry to the user-information storage unit 47 as to whether user information of the user who has entered the attendance information is already stored in the user-information storage unit 47 or, in other words, is already stored in the nonvolatile memory 25 of the operating unit 2 (t105). The user-information storage unit 47 checks the already stored user information and sends a result of the check to the user-information processing unit 46 as a response (t106).

If the user information of the user who has entered the attendance information is already stored in the operating unit 2 (i.e., the user information is already acquired), the user-information processing unit 46 sends a notice that the corresponding user information is already stored to the data processing unit 42 (t107). The data processing unit 42 completes the processes (t108).

On the other hand, if the user information of the user who has entered the attendance information is not stored in the operating unit 2 yet (i.e., the user information is not acquired yet), the user-information processing unit 46 sends a notice that the corresponding user information is not stored yet to the data processing unit 42 (t109). The data processing unit 42 sends a user-information acquisition request to acquire the corresponding user information (i.e., the not-yet-stored user information) to the controller 1 via the communication unit 41 (t110 and t111).

Upon receiving the user-information acquisition request (t112), the communication unit 31 of the controller 1 notifies the data processing unit 32 of the user-information acquisition request. The data processing unit 32 submits a request for the corresponding user information to the data storage unit 33 (t113). The data storage unit 33 retrieves the corresponding user information from the nonvolatile memory 25 and sends the user information to the data processing unit 32 as a response (t114). The data processing unit 32 sends the corresponding user information as a response via the communication unit 31 (t115 and t116).

When the user information sent from the controller 1 is received by the communication unit 41 of the operating unit 2 (t117), the data processing unit 32 notifies the user-information processing unit 46 of the corresponding user information from the communication unit 41 (t118). The user-information processing unit 46 requests the user-information storage unit 47 to store the corresponding user information (t119). The user-information storage unit 47 stores the user information in the nonvolatile memory 25 of the operating unit 2 (t120). The user-information processing unit 46 notifies the data processing unit 42 of completion of storing the user information (t121). The data processing unit 42 completes the processes (t122).

The operating unit 2 thus acquires, from the controller 1, user information in response to entry of attendance information.

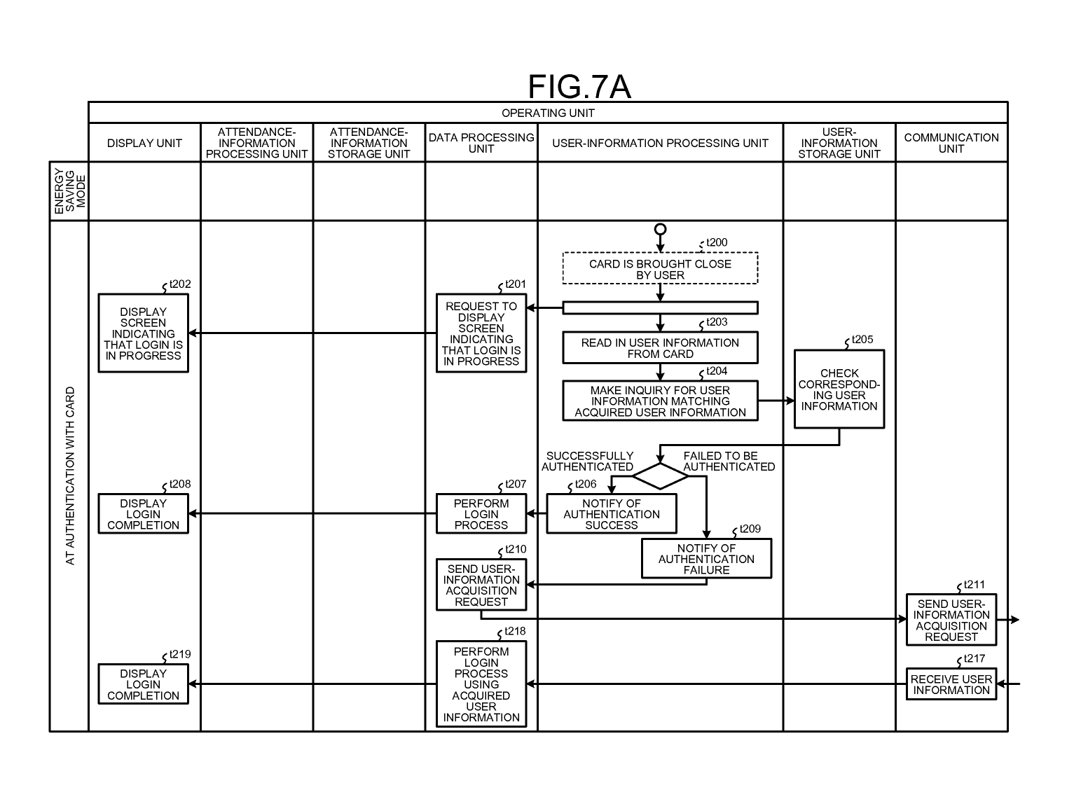

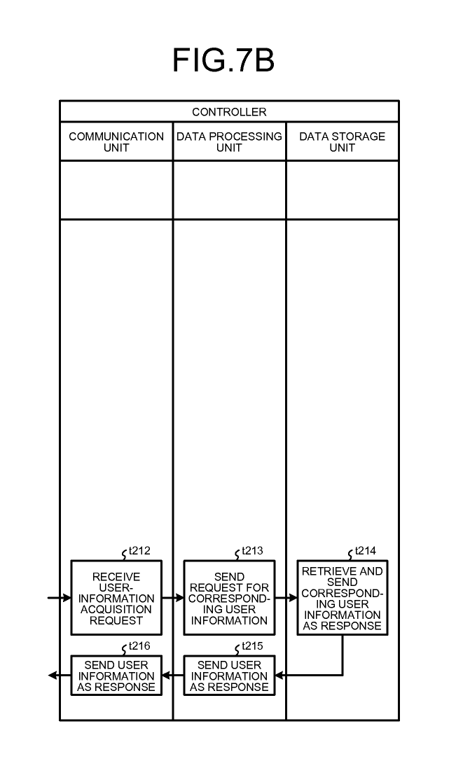

Operations for user authentication using an ID card and user information stored in the nonvolatile memory 25 of the operating unit 2 are described below with reference to the flows of the operations illustrated in FIGS. 7A and 7B.

When an ID card (which is denoted as “CARD” in FIG. 7B) is brought close to the card reader 4 by a user (t200), the operating unit 2 (and the controller 1) starts starting up as described earlier.

The data processing unit 42 requests the display unit 43 to display a screen indicating that login is in progress (t201). The display unit 43 performs control operations to cause the display device 26 to display the screen indicating that login is in progress. Furthermore, at this time, the user-information processing unit 46 acquires user information read in by the card reader 4 from the ID card (t203). The user-information processing unit 46 makes inquiry to the user-information storage unit 47 for user information matching the acquired user information (t204).

The user-information storage unit 47 checks whether the user information requested from the user-information processing unit 46 is stored in the nonvolatile memory 25 (t205) and sends a result of the check as a response. For instance, if the corresponding user information is stored, the user-information storage unit 47 sends the information to the user-information processing unit 46 as the response; otherwise, the user-information storage unit 47 sends information (e.g., error information) indicating that the information is not stored to the user-information processing unit 46 as the response.

If the user information, about which the query is made, is sent from the user-information storage unit 47 as the response, the user-information processing unit 46 judges that the user is successfully authenticated and notifies the data processing unit 42 of the authentication success (t206).

The data processing unit 42 sends a notice telling the controller 1 to enable the currently-authenticated user to use the image forming apparatus 100 as a login process. Although not illustrated in FIG. 7B, the controller 1 enables the currently-authenticated user to use the image forming apparatus 100 in response to the notice. The data processing unit 42 sends a login completion notice to the display unit 43 (t207). In response to the login completion notice, the display unit 43 displays an indication of login completion (t208).

On the other hand, if the requested user information is not sent from the user-information storage unit 47 as the response (for instance, if error information is sent from the user-information storage unit 47 as the response), the user-information processing unit 46 judges that the user has failed to be authenticated and notifies the data processing unit 42 of the authentication failure (t209).

Upon being notified of the authentication failure, the data processing unit 42 sends a user-information acquisition request to the controller 1 via the communication unit 41 to acquire user information of the corresponding user (t210 and t211). It is assumed that the controller 1 has started up and is communicably connected with the operating unit 2. Otherwise, the communication unit 41 waits for the controller 1 to start up and be communicably connected with the communication unit 41.

Processes at t212 through t216 illustrated in FIG. 7B are similar to the above-described processes (at t112 through t116) performed by the controller 1. Through the processes, the user information is sent from the controller 1 to the operating unit 2 as a response. The communication unit 41 of the operating unit 2 receives the user information and passes the user information to the data processing unit 42 (t217).

The data processing unit 42 performs the login process using the acquired user information (t218). In this example, the data processing unit 42 sends a notice telling the controller 1 to enable the currently-authenticated user to use the image forming apparatus 100 and sends a login completion notice to the display unit 43. In response to the login completion notice, the display unit 43 displays the indication of login completion (t219). Because user information of all users is stored in the controller 1, so long as a login attempt is made by an authorized user, the login process is to be performed with the user information of that user. Although not illustrated, if a login attempt is made by an unauthorized user (put another way, the data processing unit 42 notifies the controller 1 if corresponding user information is not acquired from the controller 1 where the user information of all the users is stored). Upon receiving the notice, the controller 1 disables the user to use the image forming apparatus 100.

### Second Embodiment

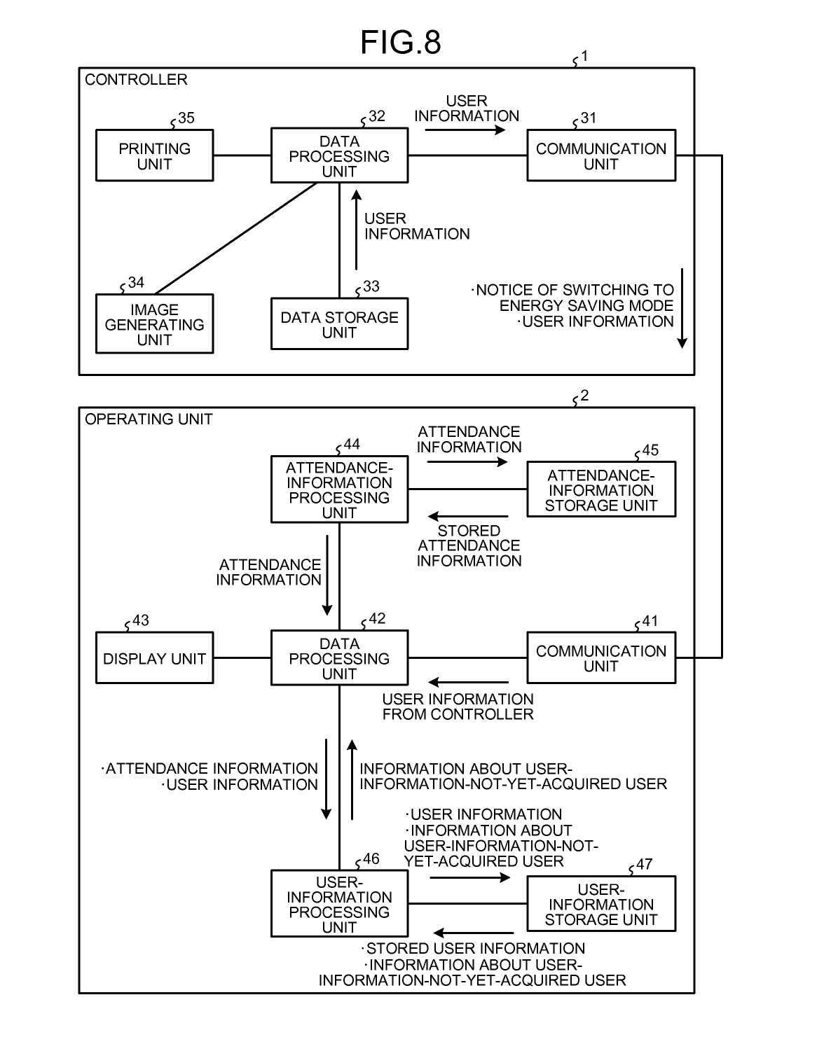

A second embodiment differs from the first embodiment in timing when to acquire user information, which is not stored in the nonvolatile memory 25 of the operating unit 2, from the controller 1. The image forming apparatus 100 of the second embodiment is similar in hardware structure to that of the first embodiment and repeated description is omitted. Software architecture of the controller 1 and the operating unit 2 serving as the control system of the image forming apparatus 100 according to the second embodiment (FIG. 8) is also basically similar to that of the first embodiment except for processing timing and information to be exchanged.

In the first embodiment described above, the user information is checked and, if the user information is not stored in the nonvolatile memory 25 of the operating unit 2, the corresponding user information is acquired from the controller 1 (acquisition pattern A). However, frequent updating of attendance information can undesirably increase the number of communications between the controller 1 and the operating unit 2 during particular hours, such as morning hours when a larger number of users clock in. In a situation where the signaling speed between the controller 1 and the operating unit 2 is low or the like, time taken by the operating unit 2 to acquire user information of one user from the controller 1 is added to waiting time of another user who enters attendance information after the one user. As a result, the waiting time is undesirably further increased.

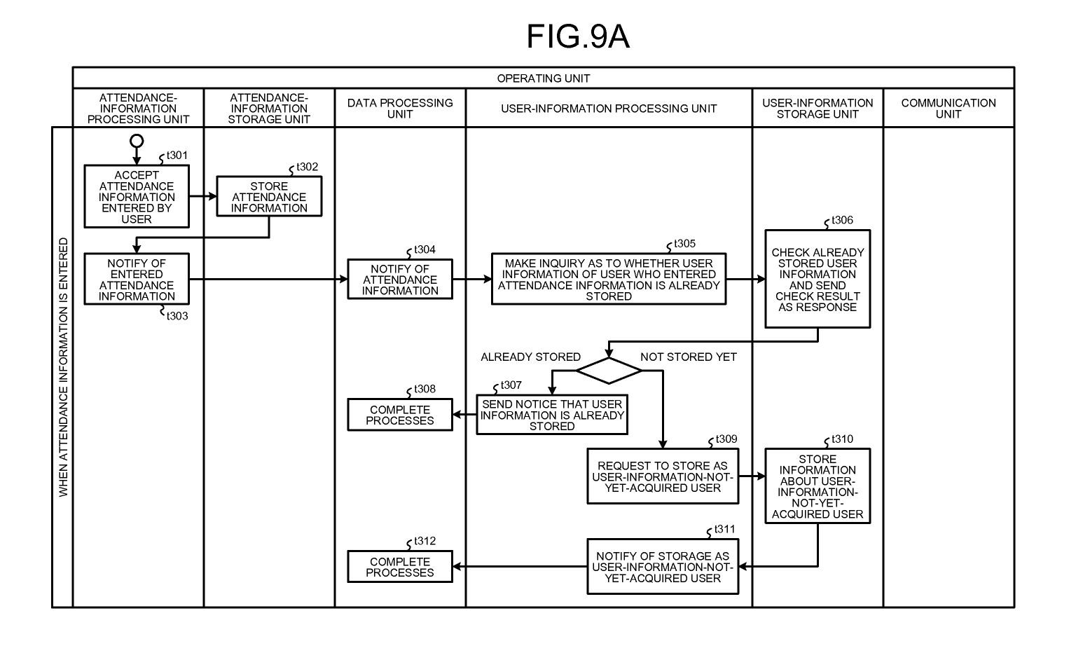

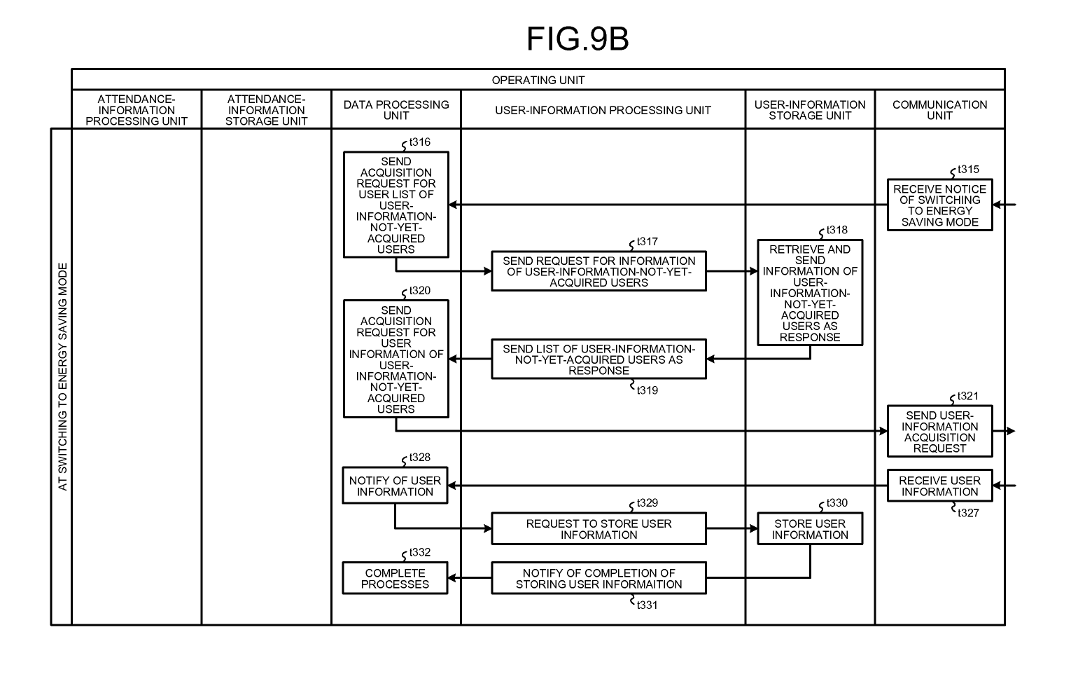

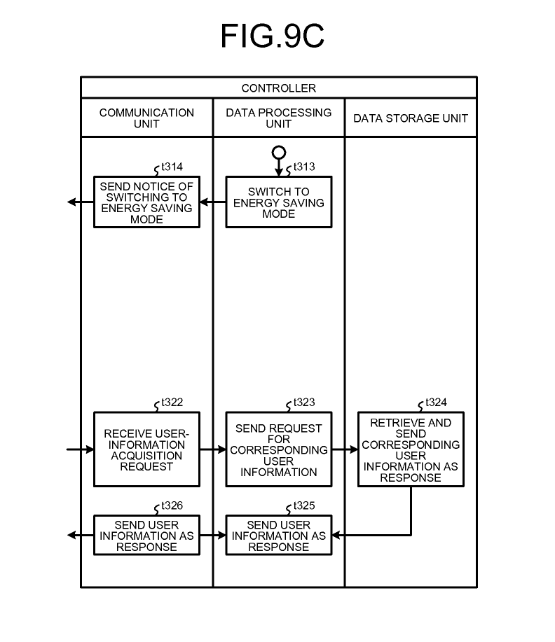

Therefore, in the second embodiment, the operating unit 2 does not acquire not-stored-yet user information from the controller 1 each time attendance information is entered, but manages a user(s) whose user information is not stored in the operating unit 2 and therefore needs to be acquired from the controller 1 as “user-information-not-yet-acquired user”. More specifically, as illustrated in FIG. 9A, if user information of a user who has entered attendance information is not stored yet, the user-information processing unit 46 requests the user-information storage unit 47 to store as a user-information-not-yet-acquired user (t309). In response to the request, the user-information storage unit 47 stores information (information, such as an employee number, which is contained in the attendance information and by which the employee can be identified) about the user-information-not-yet-acquired user in the nonvolatile memory 25 (t310). The user-information processing unit 46 sends a notice that the user who has entered the attendance information is stored as the user-information-not-yet-acquired user to the data processing unit 42 (t311). Upon receiving the notice, the data processing unit 42 completes the processes performed by the operating unit 2 (t312).

The data processing unit 42 regularly checks the number of the user-information-not-yet-acquired users. When the number of the user-information-not-yet-acquired users reaches a given number, the data processing unit 42 acquires a list of not-yet-stored user information from the controller 1 based on information about the user-information-not-yet-acquired users stored in the user-information storage unit 47 (acquisition pattern B). Alternatively, the operating unit 2 may acquire user information of the user-information-not-yet-acquired users from the controller 1 immediately before the image forming apparatus 100 switches to the energy saving mode (acquisition pattern C).

In the acquisition pattern C, more specifically, the operating unit 2 and the controller 1 operate as illustrated in FIGS. 9B and 9C. Operations specific to the second embodiment, excluding operations which are common between the first and second embodiments, are described below.

Immediately before switching to the energy saving mode, the data processing unit 32 of the controller 1 transmits a notice of switching to the energy saving mode to the operating unit 2 via the communication unit 31 (t313 and t314).

When the notice of switching to the energy saving mode is received by the communication unit 41 of the operating unit 2 (t315), the data processing unit 42 sends a request for a user list of user-information-not-yet-acquired users to the user-information processing unit 46 (t316).

The user-information processing unit 46 sends a request for information of the user-information-not-yet-acquired users to the user-information storage unit 47 (t317). The user-information storage unit 47 retrieves information of the user-information-not-yet-acquired users from the nonvolatile memory 25 and sends the information to the user-information processing unit 46 as a response (t318).

The user-information processing unit 46 sends a list of the user-information-not-yet-acquired users acquired from the user-information storage unit 47 to the data processing unit 42 as a response (t319).

The data processing unit 42 sends, based on the acquired list of the user-information-not-yet-acquired users, an acquisition request for user information of the user-information-not-yet-acquired users to the controller 1 via the communication unit 41 (t320 and t321).

Processes at t301 through t308 illustrated in FIG. 9A are same as the processes at t101 through t108 of the first embodiment illustrated in FIG. 6A. Processes at t321 through t332 illustrated in FIGS. 9B and 9C are same as the processes at t111 through t122 of the first embodiment illustrated in FIGS. 6A and 6B.

The image forming apparatus according to the second embodiment can not only reduce waiting time in user authentication but also reduce waiting time in entry of attendance information in a situation where attendance information is frequently updated.

### Third Embodiment

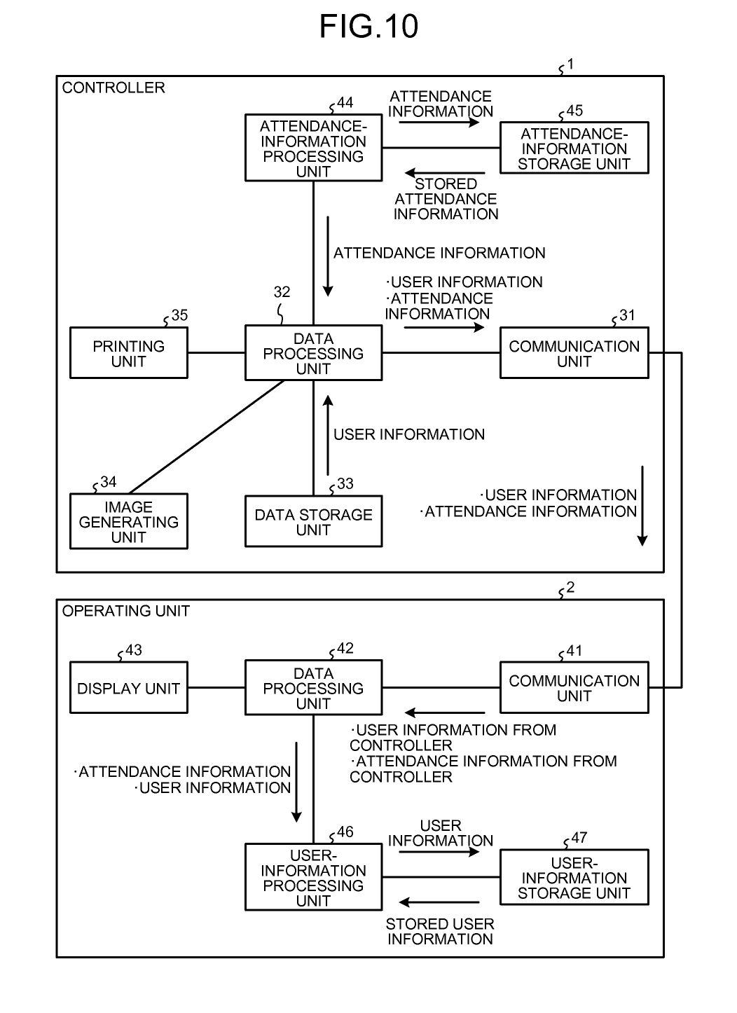

A third embodiment differs from the first and second embodiments in that attendance information, which is stored in the operating unit 2 in the first and second embodiments, is stored in the controller 1. Software architecture of the controller 1 and the operating unit 2 serving as the control system of the image forming apparatus 100 according to the third embodiment differs from that of the first and second embodiments. As illustrated in FIG. 10, the attendance-information processing unit 44 and the attendance-information storage unit 45 are included in the controller 1. The image forming apparatus 100 of the third embodiment is similar in hardware structure to that of the first and second embodiments and repeated description is omitted.

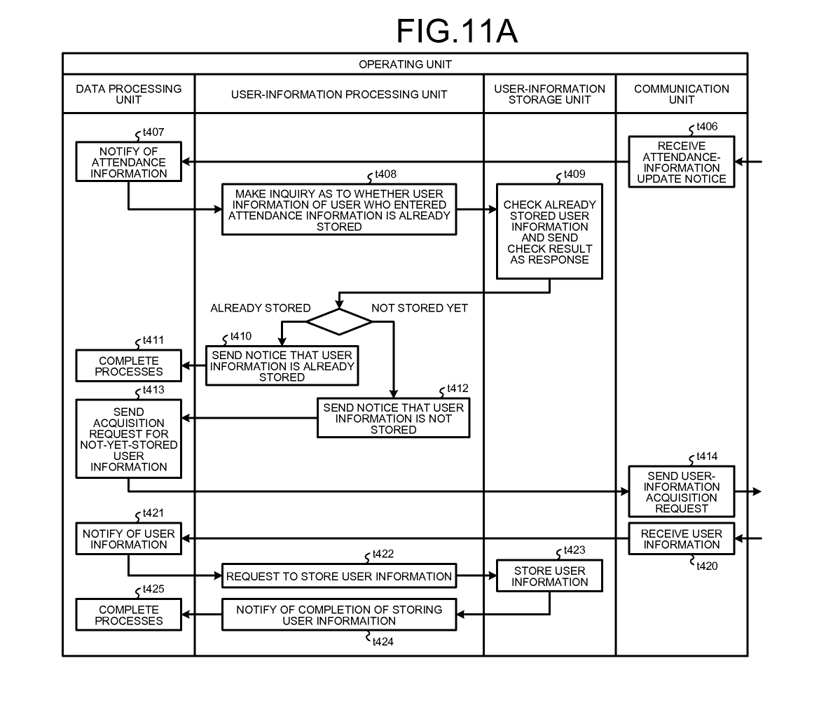

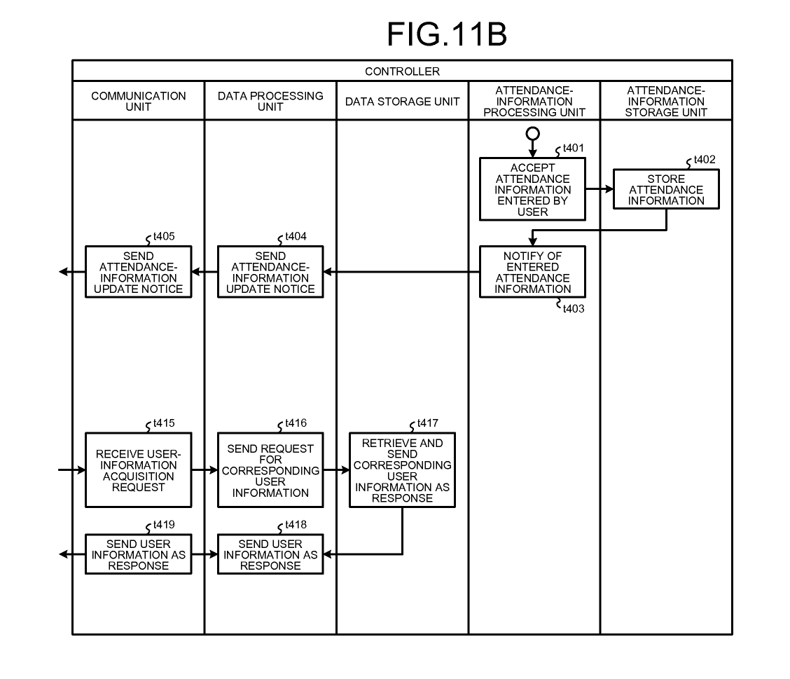

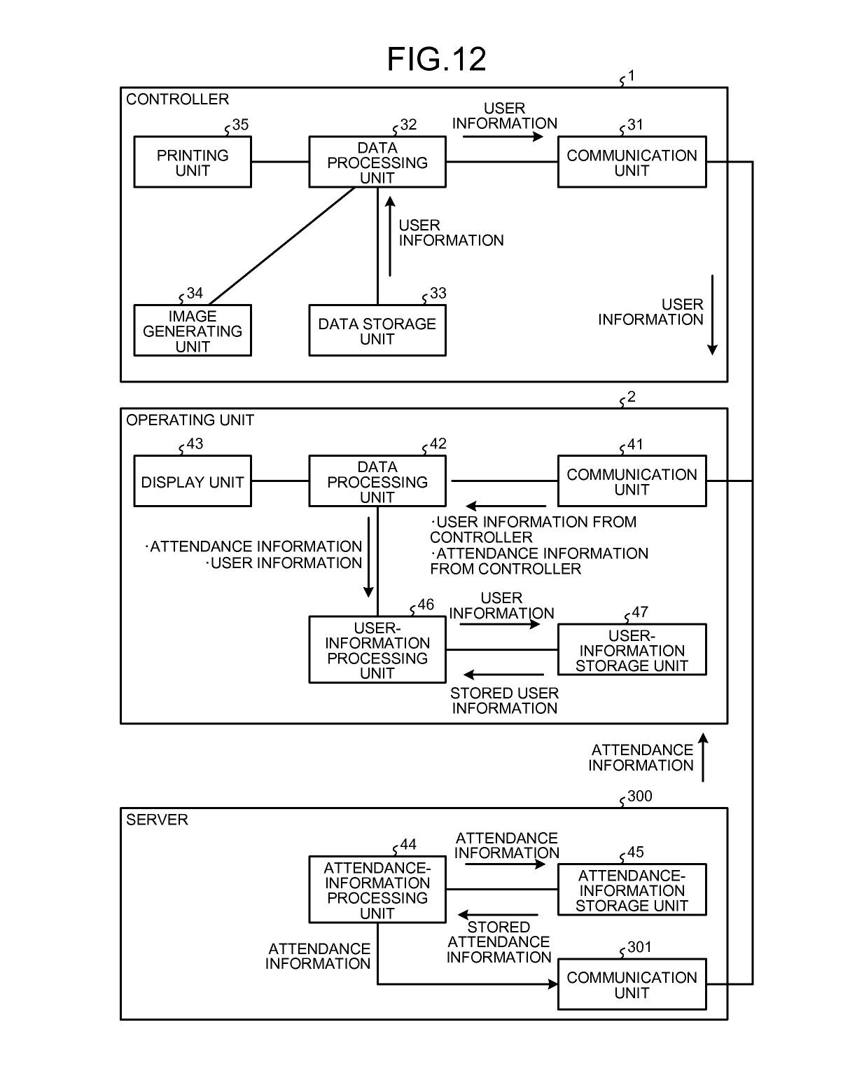

The third embodiment, in which the operating unit 2 does not include the attendance-information processing unit 44 and the attendance-information storage unit 45, is advantageous in that many of resources of the operating unit 2 can be allocated to management of user information. Flows of operations related to acquisition of user information in the image forming apparatus 100 configured as described above are illustrated in FIGS. 11A and 11B.

As illustrated in FIGS. 11A and 11B, the third embodiment differs from the first embodiment (or the second embodiment) in the following operations. The attendance-information processing unit 44 on the controller 1 accepts entered attendance information (t401). The attendance-information storage unit 45 stores the attendance information (in the nonvolatile memory 15) (t402). The controller 1 sends a notice of the entered attendance information to the operating unit 2 (t403 through t405). The notice is received by the communication unit 41 of the operating unit 2 (t406). The operations of the third embodiment, excluding the above-described operations, are similar to those of the first embodiment and repeated description is omitted. Processes at t401 through t403 illustrated in FIG. 11B are same as the processes at t101 through t103 of the first embodiment illustrated in FIG. 6A. Processes at t407 through t425 illustrated in FIGS. 11A and 11B are same as the processes at t104 through t122 of the first embodiment illustrated in FIGS. 6A and 6B.

Also in the third embodiment, timing for acquiring not-yet-acquired user information from the controller 1 may be set to one of the above-described three acquisition patterns: (1) acquiring not-yet-collected user information each time attendance information is updated (the acquisition pattern A), (2) acquiring user information when the number of data of the “user-information-not-yet-acquired users” reaches a given number (the acquisition pattern B), and (3) acquiring, immediately before switching to the energy saving mode, user information of users accumulated up to this point in time and managed as the “user-information-not-yet-acquired users” (the acquisition pattern C).

### Fourth Embodiment

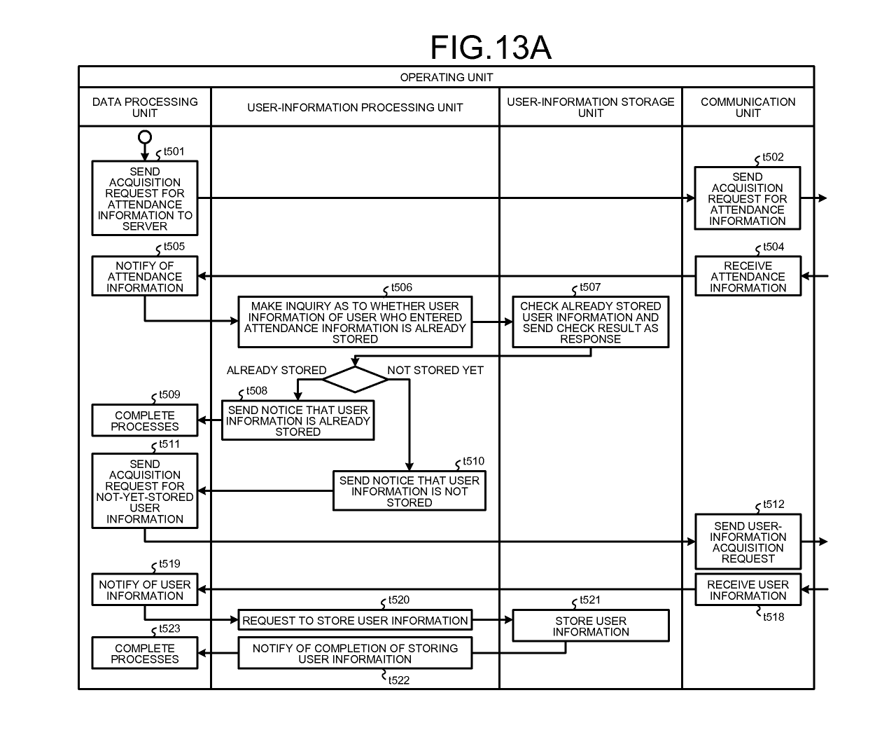

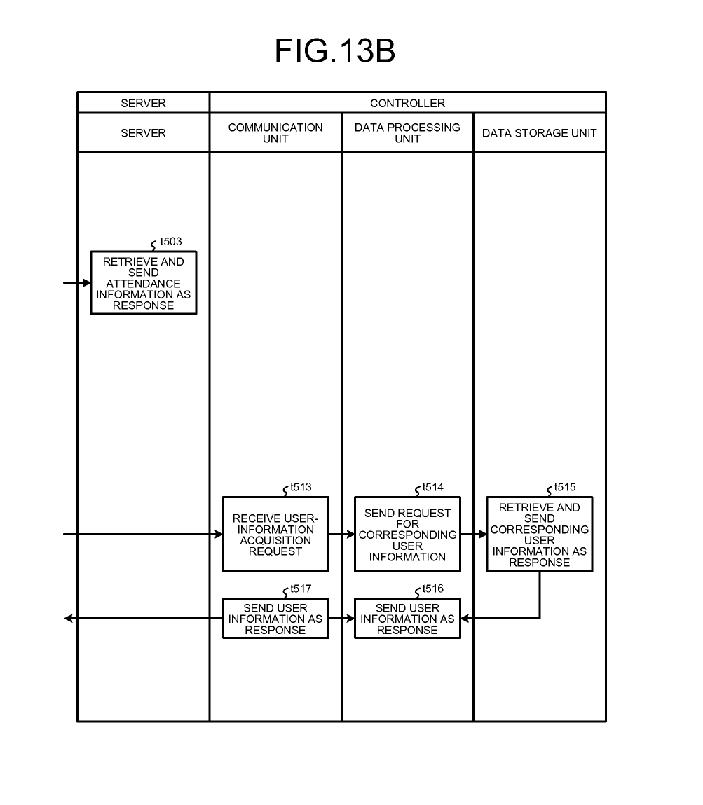

In a fourth embodiment, attendance management is performed by an external server rather than by the image forming apparatus 100. In the first to third embodiments described above, attendance information is managed by (the operating unit 2 or the controller 1 of) the image forming apparatus 100. By contrast, in the fourth embodiment, the attendance-information processing unit 44 and the attendance-information storage unit 45 are included in an external server (denoted as “SERVER” in FIG. 13B) 300, where attendance information is managed.

In the fourth embodiment configured as described above, as illustrated in FIGS. 13A and 13B, the data processing unit 42 of the operating unit 2 of the image forming apparatus 100 sends a request for attendance information to the external server 300 via the communication unit 41 (t501 and t502). In response to the request, the external server 300 retrieves the attendance information and sends the attendance information as a response (t503). The data processing unit 42 acquires the information via the communication unit 41 (t504). At the remaining processes (i.e., t505 and processes subsequent thereto), the operating unit 2 distinguishes a user whose user information is not stored yet and acquires the not-stored-yet user information from the controller 1. Processes at t505 through t523 illustrated in FIGS. 13A and 13B are same as the processes at t104 through t122 of the first embodiment illustrated in FIGS. 6A and 6B.

Functions and operations of the units in the software architecture of the controller 1 and the operating unit 2 and the attendance-information processing unit 44 and the attendance-information storage unit 45 of the external server 300 serving as the control system of the image forming apparatus 100 according to the fourth embodiment are similar to those of the other embodiments except for that attendance information is acquired by the data processing unit 42 of the operating unit 2 from the attendance-information processing unit 44 of the external server 300 via the communication unit 41. The attendance-information processing unit 44 and the attendance-information storage unit 45 included in the external server are implemented in control means including a CPU, a main memory, and a control program and included in the external server. The attendance information is stored in storage means, such as an HDD, included in the external server.

The fourth embodiment is advantageous in that a plurality of the image forming apparatuses 100 can utilize same attendance information because the attendance information is managed by the server. The attendance information may be stored in a single server.

The embodiments have been described above. According to the image forming apparatus 100 in the embodiments described above, information of users who are highly likely to use the image forming apparatus 100 (i.e., users who have clocked in), is stored in the operating unit 2 with higher priority than the other users, and thus waiting time in user authentication using an ID card can be reduced.

The control programs to be executed by the image forming apparatus 100 according to the embodiments are provided as being stored in ROMs (which are the program ROM 12 in the controller 1 and the program ROM 22 in the operating unit 2) or the like in advance. The control programs may be configured to be provided as being recorded in a non-transitory computer-readable recording medium such as a CD-ROM, an FD (flexible disk), a CD-R, or a DVD (digital versatile disk) as an installable file or an executable file. The control programs may be configured so as to be stored in a computer connected to a network such as the Internet and provided or distributed by being downloaded via the network.

The configurations and operations of the image forming apparatus for user authentication described above are applicable not only to multifunction peripherals having at least two functions of a copier function, a printer function, a scanner function, and a facsimile function but also applicable to image forming apparatuses such as copiers, printers, scanners, and facsimiles. In the embodiments described above, an ID card (an IC card, a magnetic card, or the like) is used as the user-information recording medium; however, the user-information recording medium is not limited thereto. Alternatively, any user-information recording medium (e.g., a portable terminal such as a smartphone) may be used. When such a user-information recording medium is used, the image forming apparatus 100 may be configured to include a corresponding reader (reading device) in lieu of the card reader 4.

According to an aspect of the present invention, waiting time in user authentication can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An image-forming-apparatus control system comprising:
a main body; and
an information processing terminal used as an operating unit of the image forming apparatus, controlled independently of the main body of the image forming apparatus and including a reader configured to read in user information from a user-information recording medium,
the main body of the image forming apparatus including a first user-information storage unit configured to store user information,
the information processing terminal including:
a data processing unit configured to acquire attendance information;
a user-information processing unit configured to acquire, from the main body of the image forming apparatus, user information of a user who has clocked in determined based on the attendance information and acquire user information read in by the reader from the user-information recording medium for user authentication; and
a second user-information storage unit configured to store the user information of the user who has clocked in, acquired from the main body of the image forming apparatus, and
the user-information processing unit being configured to perform user authentication by using the user information stored by the second user-information storage unit and the user information read in by the reader from the user-information recording medium for user authentication.

2. The image-forming-apparatus control system according to claim 1, wherein, each time the data processing unit acquires attendance information, the user-information processing unit acquires, from the main body of the image forming apparatus, user information of a user who has clocked in determined based on the attendance information if the user information of the user is not acquired yet.

3. The image-forming-apparatus control system according to claim 1, wherein
if user information of users who have clocked in determined based on attendance information acquired by the data processing unit is not acquired yet, the user-information processing unit manages the users as user-information-not-yet-acquired users, and
when the number of the user-information-not-yet-acquired users reaches a given number, the user-information processing unit acquires user information of the user-information-not-yet-acquired users from the main body of the image forming apparatus.

4. The image-forming-apparatus control system according to claim 1,
wherein, if user information of a user who has clocked in determined based on attendance information acquired by the data processing unit is not acquired yet, the user-information processing unit manages the user as a user-information-not-yet-acquired user and
when the image forming apparatus switches to an energy saving mode, the user-information processing unit acquires user information of the user-information-not-yet-acquired user from the main body of the image forming apparatus.

5. The image-forming-apparatus control system according to claim 1, wherein
the information processing terminal includes:
an attendance-information processing unit configured to accept entry of the attendance information and manages the attendance information: and
an attendance-information storage unit configured to store the attendance information, and
the attendance-information processing unit causes the attendance-information storage unit to store the accepted attendance information to manage the attendance information in the information processing terminal.

6. The image-forming-apparatus control system according to claim 5, wherein
the attendance-information processing unit and the attendance-information storage unit are included in the main body of the image forming apparatus rather than in the information processing terminal, and
the attendance-information processing unit manages the attendance information in the image forming apparatus.

7. The image-forming-apparatus control system according to claim 5, wherein
the attendance-information processing unit and the attendance-information storage unit are included in an external server rather than in the information processing terminal, and
the attendance-information processing unit manages the attendance information in the external server.

8. A control method for an image-forming-apparatus control system for an image forming apparatus including a main body and an information processing terminal used as an operating unit of the image forming apparatus, controlled independently of the main body of the image forming apparatus and including a reader for reading in user information from a user-information recording medium, the control method comprising:
in the main body of the image forming apparatus,
storing, by a first user-information storage unit, user information;
in the information processing unit,
acquiring, by a data processing unit, attendance information;
acquiring, by a user-information processing unit, user information of a user who has clocked in determined based on the attendance information from the main body of the image forming apparatus;
storing, by a second user-information storage unit, the user information of the user who has clocked in, acquired from the main body of the image forming apparatus;
acquiring, by the user-information processing unit, user information read in by the reader from the user-information recording medium for user authentication; and
performing, by the user-information processing unit, user authentication by using the user information stored by the second user-information storage unit and the user information read in by the reader from the user-information recording medium for user authentication.

9. A computer program product comprising a non-transitory computer-readable medium containing an information processing program for an image-forming-apparatus control system for an image forming apparatus including a main body storing therein user information, and an information processing terminal used as an operating unit of the image forming apparatus, controlled independently of the main body of the image forming apparatus and including a reader for reading in user information from a user-information recording medium, the program causing a computer of the image-forming-apparatus control system to perform:
acquiring attendance information;
acquiring, from the main body of the image forming apparatus, user information of a user who has clocked in determined based on the attendance information;
storing the user information of the user who has clocked in acquired from the main body of the image forming apparatus;
acquiring user information read in by the reader from the user-information recording medium for user authentication; and
performing user authentication by using the user information stored at the storing and the user information read in by the reader from the user-information recording medium for user authentication.
